(19) United States
(12) Patent Application Publication
(10) Pub. No.: US 2023/0365306 A1
(43) Pub. Date: Nov. 16, 2023

(54) SYSTEM AND METHOD FOR DISPENSING FLUID FROM A CONTAINER WITH A STACKED ARRANGEMENT OF CROSS-SLIT VALVES

(71) Applicant: Nexa3D Inc., Ventura, CA (US)

(72) Inventors: Miguel Cuevas Sandoval, Camarillo, CA (US); Francis Kenyon Whetsell, Ventura, CA (US); Cesar Antonio Gonzales, Van Nuys, CA (US); Beneil Eisavi, Ventura, CA (US)

(21) Appl. No.: 17/663,632

(22) Filed: May 16, 2022

(51) Int. Cl. B65D 47/20; B65D 1/06; F16K 15/14

(52) U.S. Cl. CPC B65D 47/2031; B65D 1/06; F16K 15/1471; B65D 2547/063

(57) ABSTRACT

A dispensing system may include a fluid container and a container receptacle. The fluid container may include a stacked arrangement of cross-slit valves through which a rigid projecting member of the container receptacle may be inserted through. Upon insertion of the rigid projecting member therethrough, fluid from the fluid container may flow into a tank of a 3D printing system through a dispensing channel of the rigid projecting member. The stacked arrangement of cross-slit valves acts a partial seal around the rigid projecting member, preventing fluid from leaking out of the fluid container from the outer surface of the rigid projecting member, while at the same time allowing ambient air to flow into the fluid container so as to backfill the partial vacuum created by the dispensing of the fluid from the fluid container.

### FIELD OF THE INVENTION

The present invention relates to a system and method for dispensing fluid from a fluid container, and more particularly relates to a fluid container with a stacked arrangement of cross-slit valves.

### BACKGROUND

While many advancements have been made in the field of three-dimensional (3D) printing, there is still room for improvement on certain aspects including the fluid dispensing system that dispenses resin from a resin bottle into the tank of the 3D printing system.

### SUMMARY OF THE INVENTION

In accordance with one embodiment of the invention, a dispensing system may include a fluid container and a container receptacle. The fluid container may include a stacked arrangement of cross-slit valves through which a rigid projecting member of the container receptacle may be inserted. Upon insertion of the rigid projecting member through the stacked arrangement of cross-slit valves, fluid (e.g., a viscous photo-curable resin) from the fluid container may flow into a tank of a 3D printing system through a dispensing channel of the rigid projecting member. The stacked arrangement of cross-slit valves acts a partial seal around the rigid projecting member, preventing fluid from leaking out of the fluid container from the outer surface of the rigid projecting member, while at the same time allowing ambient air to flow into the fluid container so as to backfill the partial vacuum created by the dispensing of the fluid from the fluid container.

Each of the cross-slit valves includes a plurality of petals that in a closed arrangement forms a complete seal that blocks fluid from being dispensed from the fluid container. Respective tips of the petals may point away from the opening of the fluid container. Upon insertion of the rigid projecting member therethrough, the respective tips of the petals may be pushed away from a central axis of the fluid container, allowing fluid to flow into the tank of the 3D printing system through the dispensing channel of the rigid projecting member and ambient air to flow into the fluid container.

These and other embodiments of the invention are more fully described in association with the drawings below.

### BRIEF DESCRIPTION OF THE DRAWINGS

FIG. 1A depicts a perspective view of a tank that is fluidly connected with a container receptacle, in accordance with one embodiment of the invention.

FIG. 1B depicts a top view of the tank and the container receptacle shown in FIG. 1, in accordance with one embodiment of the invention.

FIG. 1C depicts a cross-sectional view of the tank and the container receptacle along line I-I shown in FIG. 1B, in accordance with one embodiment of the invention.

FIG. 2A depicts a perspective view of a fluid dispensing system before a fluid container has been inserted into the container receptacle, in accordance with one embodiment of the invention.

FIG. 2B depicts a perspective view of the fluid dispensing system after the fluid container has been inserted into the container receptacle, in accordance with one embodiment of the invention.

FIG. 2C depicts a top view of the fluid dispensing system shown in FIG. 2B, in accordance with one embodiment of the invention.

FIG. 2D depicts a cross-sectional view of the fluid dispensing system along line II-II shown in FIG. 2C, in accordance with one embodiment of the invention.

FIG. 2E depicts a magnified view of rectangular portion III shown in FIG. 2D, in accordance with one embodiment of the invention.

FIG. 3A depicts a top-side perspective view of a cap, in accordance with one embodiment of the invention.

FIG. 3B depicts a bottom-side perspective view of the cap shown in FIG. 3A, in accordance with one embodiment of the invention.

FIG. 3C depicts a top view of the cap shown in FIG. 3A, in accordance with one embodiment of the invention.

FIG. 3D depicts a bottom view of the cap shown in FIG. 3A, in accordance with one embodiment of the invention.

FIG. 3E depicts a side view of the cap shown in FIG. 3A, in accordance with one embodiment of the invention.

FIG. 3F depicts a cross-sectional view of the cap along line Iv-Iv shown in FIG. 3E, in accordance with one embodiment of the invention.

FIG. 4A depicts a top-side perspective view of a cap that is sealed on one end with a lid, in accordance with one embodiment of the invention.

FIG. 4B depicts a bottom-side perspective view of the cap and lid arrangement shown in FIG. 4A, in accordance with one embodiment of the invention.

FIG. 4C depicts a top view of the cap and lid arrangement shown in FIG. 4A, in accordance with one embodiment of the invention.

FIG. 4D depicts a bottom view of the cap and lid arrangement shown in FIG. 4A, in accordance with one embodiment of the invention.

FIG. 4E depicts a side view of the cap and lid arrangement shown in FIG. 4A, in accordance with one embodiment of the invention.

FIG. 4F depicts a cross-sectional view of the cap and lid arrangement along line V-V shown in FIG. 4E, in accordance with one embodiment of the invention.

FIG. 5A depicts a top-side perspective view of a cross-slit valve.

FIG. 5B depicts a bottom-side perspective view of the cross-slit valve shown in FIG. 5A.

FIG. 5C depicts a side view of the cross-slit valve shown in FIG. 5A.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. Descriptions associated with any one of the figures may be applied to different figures containing like or similar components/steps.

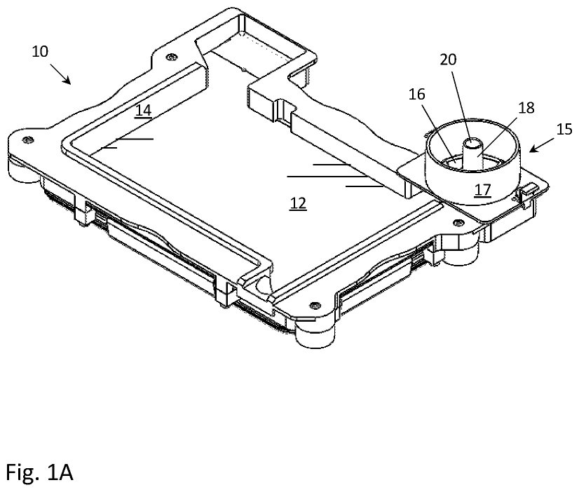

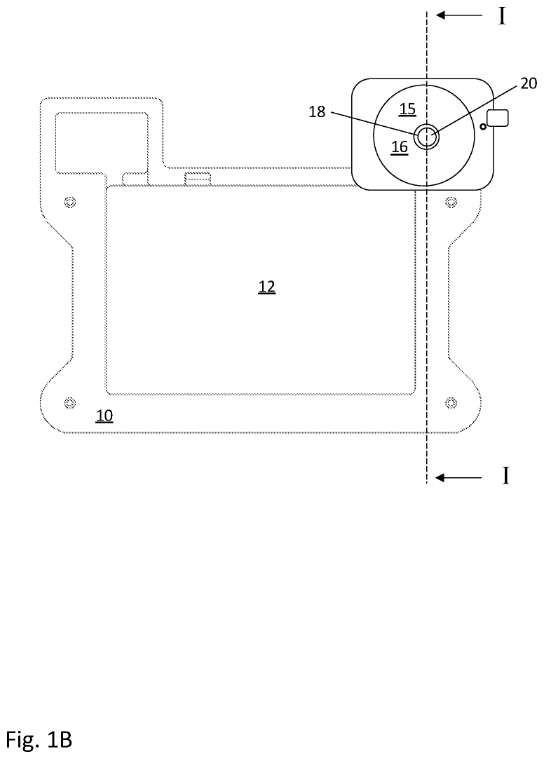

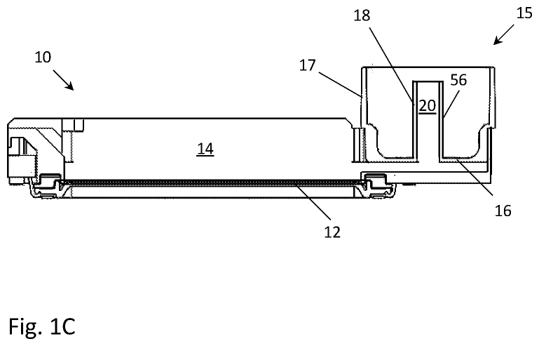

FIG. 1A depicts a perspective view of a tank 10 that is fluidly connected with a container receptacle 15. The tank 10 may be used to contain a fluid (e.g., photo-curable resin) for a 3D printing system (not shown). Additional details of the 3D printing system may be found in application Ser. No. 17/453,329, filed on 2 Nov. 2021, the contents of which are incorporated by reference herein in its entirety. The sides of the tank 10 may be formed by tank sidewalls 14, and the bottom of the tank 10 may be formed by a radiation-transparent flexible membrane 12 that allows radiation from a light source (not depicted) below the tank 10 to enter into the tank 10. Additional details of the light source may also be found in application Ser. No. 17/453,329, filed on 2 Nov. 2021.

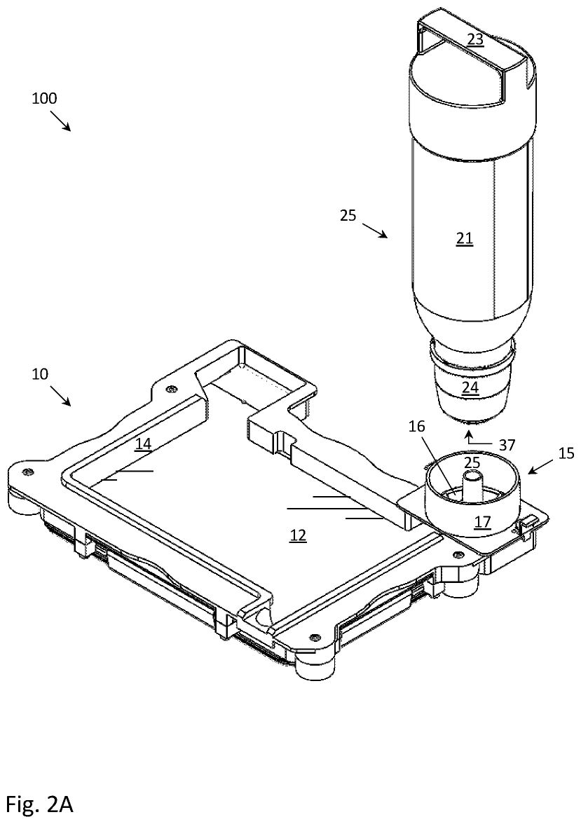

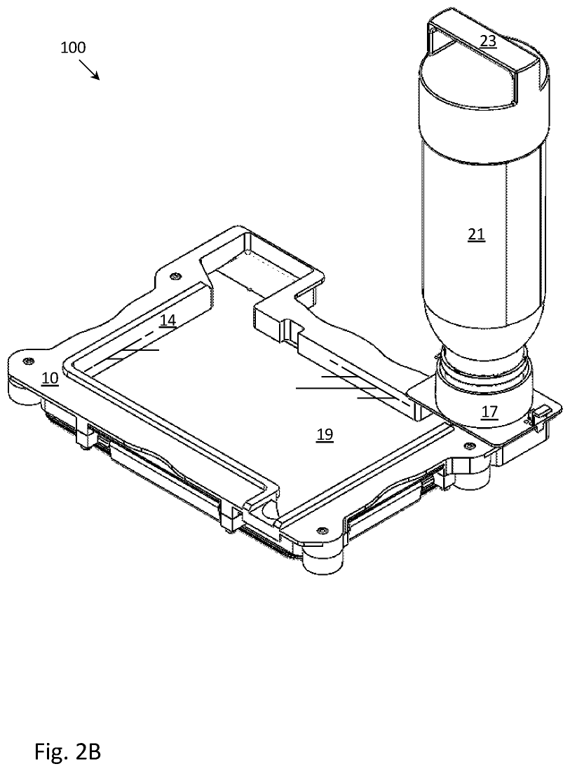

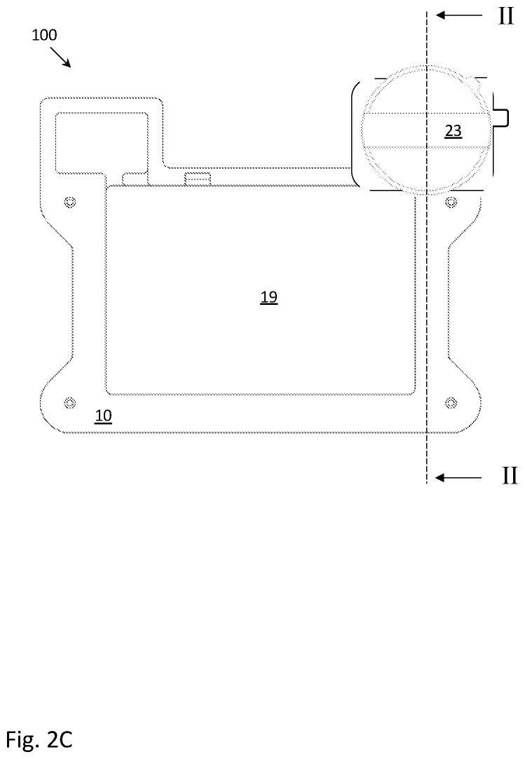

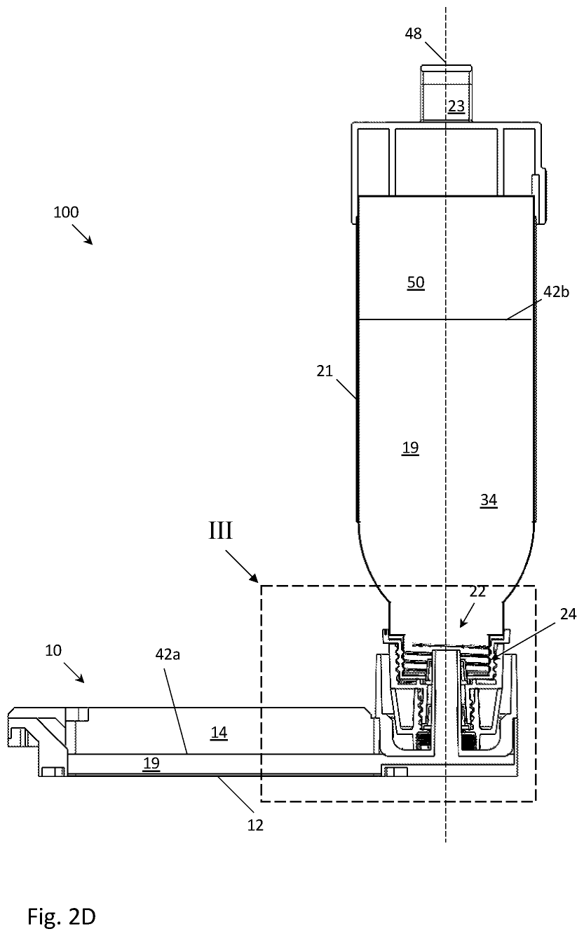

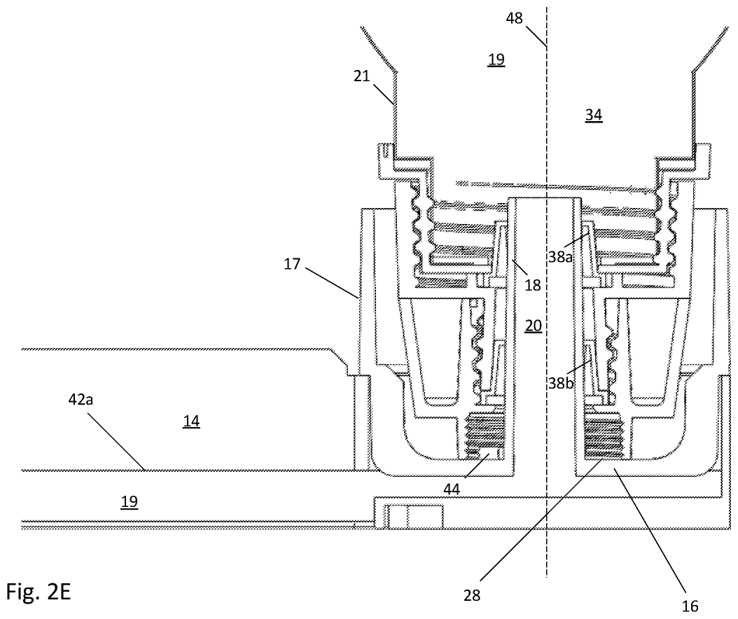

The container receptacle 15 may include a rigid projecting member 18 that projects (e.g., in a perpendicular manner) from a base portion 16 of the container receptacle 15. The base portion 16 may be encircled by a collar 17 for containing any fluid that leaks from the fluid container 25 (see FIG. 2A).

FIG. 1B depicts a top view of the tank 10 and the container receptacle 15 shown in FIG. 1. As more clearly shown in FIG. 1B, the base portion 16 of the container receptacle 15 may have an annular shape.

FIG. 1C depicts a cross-sectional view of the tank 10 and the container receptacle 15 along line I-I shown in FIG. 1B. As more clearly shown in FIG. 1C, the rigid projecting member 18 may contain a dispensing channel 20 for dispensing fluid from the fluid container 25 (see FIGS. 2A-2B) into the tank 10. In some embodiments (not depicted), the profile of the rigid projecting member 18 may be tapered, with the top end have a smaller diameter than the bottom end.

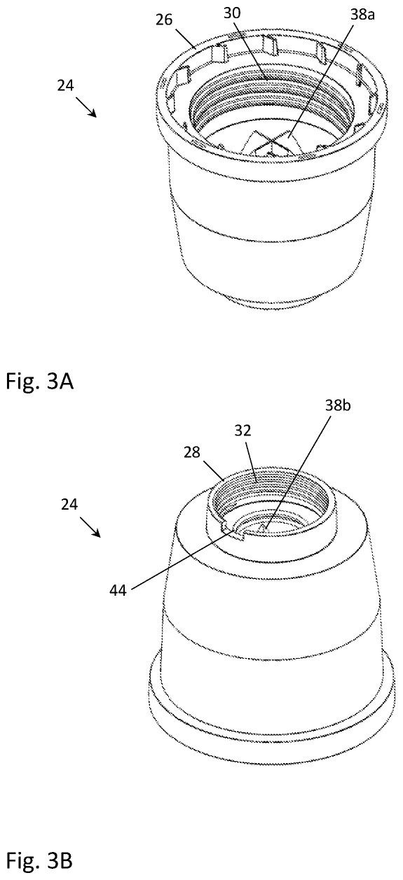

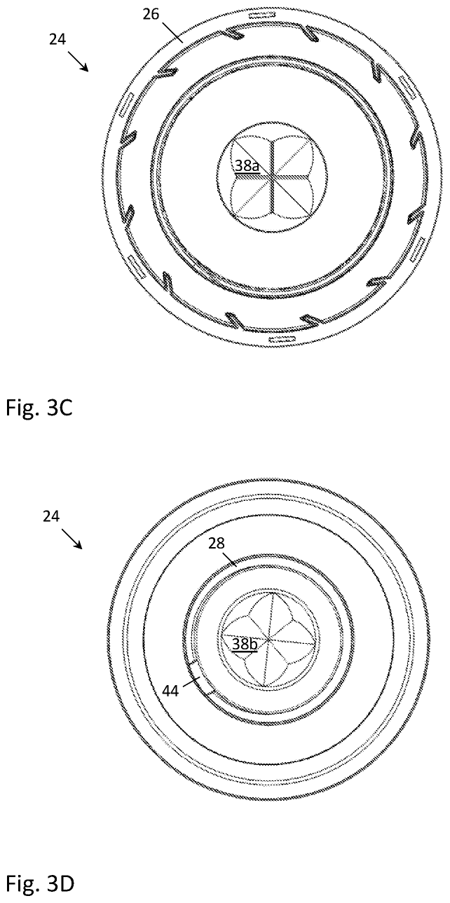

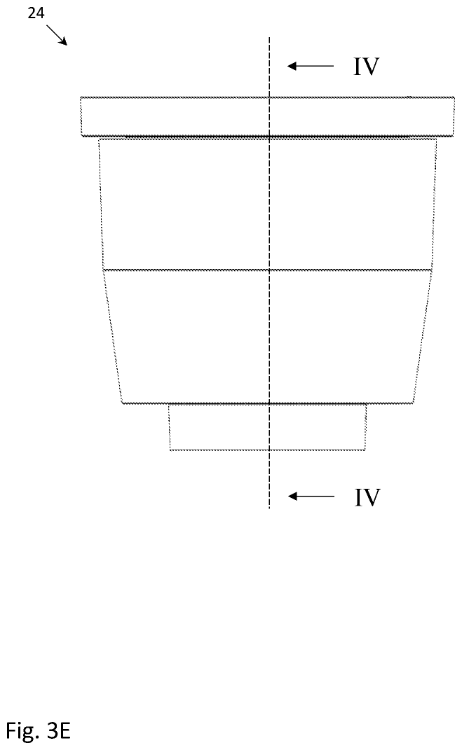

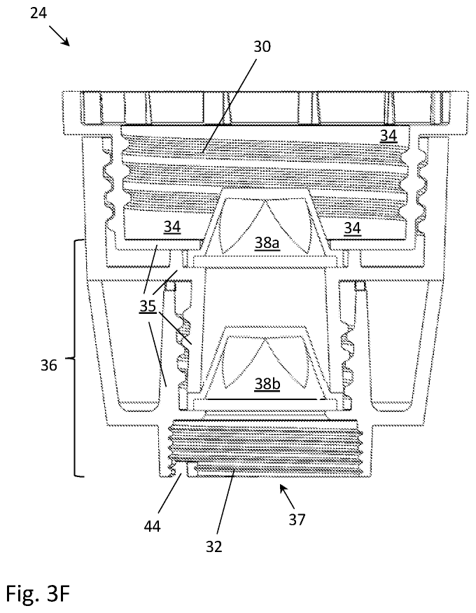

FIG. 2A depicts a perspective view of a gravity-assisted fluid dispensing system 100 before a fluid container 25 has been inserted into the container receptacle 15. The fluid container 25 may include a bottle 21 and a cap 24 that are both responsible for forming a cavity 34 (see FIG. 2D) for containing a fluid. The structure of the cap 24 will be described in detail below in connection with FIGS. 3A-3F. The fluid container 25 may also include a handle 23 for a human operator to easily grasp the top portion of the fluid container 25 (e.g., allowing the human operator to carry the fluid container 25 from one location to another location). The diameter of the collar 17 may be sized to be slightly larger than the maximum diameter of the cap 24 so as to allow the cap 24 of the fluid container 25 to be inserted (e.g., threadedly inserted, friction fit, bayonet mounted, etc.) within the collar 17.

FIG. 2B depicts a perspective view of the fluid dispensing system 100 after the fluid container 25 has been inserted into the container receptacle 15. As will be better understood in connection with the figures that follow, insertion of the fluid container 25 allows fluid 19 to flow from the fluid container 25 through the dispensing channel 20 into the tank 10 which is disposed below and fluidly connected with the fluid container 25. In FIG. 2B, the tank 10 contains fluid 19 that has flowed from the fluid container 25 into the tank 10. The flow of fluid 19 from the fluid container 25 creates a partial vacuum within the fluid container 25 which partially impedes the flow of additional fluid 19 from the fluid container 25 into the tank 10. Intermittently, ambient air flows into the fluid container 25 through a groove 44 (see FIG. 2E) on the rim of the cap 24, reducing the partial vacuum within the fluid container 25 and allowing additional fluid 19 to flow into the tank 10. Eventually, when the fluid 19 reaches a fill line 42a (see FIG. 2E), an equilibrium is reach between the force exerted on the fluid 19 within the tank 10 by the atmospheric pressure and the force of gravity acting on the fluid 10 within the fluid container 25, causing the flow of fluid 19 to stop. As fluid 19 is consumed within the tank 10 by printing operations, the amount fluid 19 within the tank 10 may intermittently decrease below the fill line 42a, causing additional fluid from the fluid container 25 to flow into the tank 10 until the fluid reaches the fill line 42a again. FIG. 2C depicts a top view of the fluid dispensing system 100 shown in FIG. 2B.

FIG. 2D depicts a cross-sectional view of the fluid dispensing system 100 along line II-II shown in FIG. 2C. As shown in the cross-sectional view, the cavity 34 which contains fluid 19 may be formed by both the bottle 21 and a portion of the cap 24 (the particular portion of the cap 24 explained in more detail below in FIG. 3F). In the example of FIG. 2D, a bottom portion of the cavity 34 is occupied by the fluid 19 and a top portion of the cavity 34 is occupied by ambient air 50. Fluid level 42b represents the top level of the fluid 19 within the cavity 34. As explained above, a partial vacuum may exist in the portion of the cavity 34 occupied by the ambient air 50.

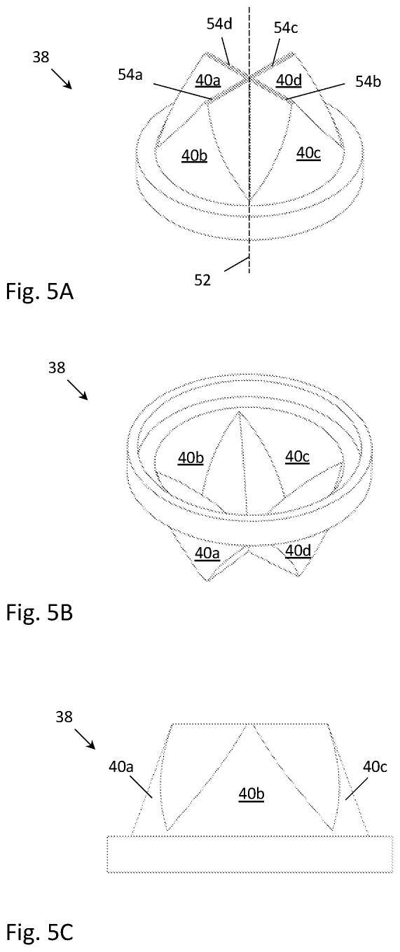

FIG. 2E depicts a magnified view of rectangular portion III shown in FIG. 2D. As shown in the magnified view, the rigid projecting member 18 is inserted through two cross-slit valves 38a, 38b of the cap 24. Due to the insertion, the respective tips of each of the petals (or flaps) of the cross-slit valves 38a, 38b may be pushed away from the central axis 48 of the fluid container 25 (see FIGS. 5A-5C for a more detailed description of the respective tips and petals of the cross-slit valves).

The cross-slit valves 38a, 38b may serve several purposes. First, when the rigid projecting member 18 is inserted into the cap 24, the cross-slit valves 38a, 38b form a partial seal around the rigid projecting member 18, preventing the fluid 19 within the fluid container 25 from leaking between the cross-slit valves 38a, 38b and the outer surface 56 of the rigid projecting member 18. At the same time, the cross-slit valves 38a, 38b allow ambient air to flow from the groove 44 into the fluid container 25 through intermittent gaps that form between the cross-slit valves 38a, 38b and the outer surface 56 of the rigid projecting member 18 when the ambient air flowing into the fluid container displaces one or more flaps of the cross-slit valves 38a, 38b. The amount of sealing is a delicate balance—too little sealing will allow fluid 19 to leak from the fluid container 25, while too much sealing will too strongly inhibit the ambient air from flowing into the partial vacuum within the fluid container 25. With too much sealing, the air will undesirably flow into the fluid container 25 from the groove 44 in large “gulps,” creating an uneven/jerky flow of the fluid 19 from the fluid container 25. The inventors have found that the stacked arrangement of two cross-slit valves 38a, 38b creates just the right amount of sealing around the rigid projecting member 18. In one embodiment, the cross-slit valves 38a, 38b may be CR 200.002 SD cross-slit valves available from miniValve International® of Oldenzaal, The Netherlands.

FIG. 3A depicts a top-side perspective view of a cap 24. When the cap 24 is secured to the bottle 21, the top rim 26 of the cap 24 may be oriented towards the opening 22 (see FIG. 2D) of the bottle 21. Top threads 30 of the cap 24 allow the cap 24 to be screwed onto the end of the bottle 21 with the opening 22. It is understood that matching threads (not depicted) may be present on the bottle 21 to receive the top threads 30 of the cap 24. While a screw-type securing mechanism has been described, it is understood that other securing mechanisms may be used to attach the cap 24 to the bottle 21, including a bayonet mount, tongue and groove mount, a friction fit mount, and ball-bearing lock type securing mechanism. A portion of the cross-slit valve 38a is visible in the top-side perspective view of the cap 24.

FIG. 3B depicts a bottom-side perspective view of the cap shown in FIG. 3A. The cap 24 may include a bottom rim 28, as well as bottom threads 32 for securing a lid (illustrated in the following figures) to the cap 24. The above-described groove 44 is more clearly visible in FIG. 3B, allowing ambient air to flow into the fluid container 25. A small portion of the cross-slit valve 38b is visible in the bottom-side perspective view of the cap 24. Bottom rim 28 of the cap 24 may also be referred to as the rim 28 of the neck body 36. FIGS. 3C, 3D and 3E depict a top, bottom and side views of the cap shown in FIG. 3A, respectively.

FIG. 3F depicts a cross-sectional view of the cap 24 along line IV-IV shown in FIG. 3E. As described above, a top portion of the cap 24 (together with the bottle 21) may form the cavity 24 for containing the fluid 19 within the fluid container 25. A bottom portion of the cap 24 includes the neck body 36 for regulating a flow of the fluid 19. An upper end of the neck body 36 is disposed adjacent to the cavity 34 and a lower end of the neck body 36 forms the opening 37 of the fluid container 25. Cross-slit valve 38a is secured to the upper end of the neck body 36 for inhibiting the fluid 19 from flowing into the neck body 36 from the cavity 37 (when the rigid projecting member 18 is not inserted). Cross-slit valve 38b is secured to the lower end of the neck body 36 for inhibiting the fluid 19 from flowing out of the opening 37 from the neck body 36 (when the rigid projecting member 18 is not inserted). Each of the cross-slit valves 38a, 38b may include a plurality of petals (see also FIG. 5A-5C) with respective tips that point away from the opening 37 of the fluid container 25. The neck body 36 may include a support member 35 for securing the cross-slit valve 38a to the upper end of the neck body 36 and cross-slit valve 38b to the lower end of the neck body 36. In some embodiments, cross-slit valve 38a is identical in shape to cross-slit valve 38b and the two may be spatially separated from one another (in the coaxial direction), e.g., in one embodiment by about 0.5″-3.0″.

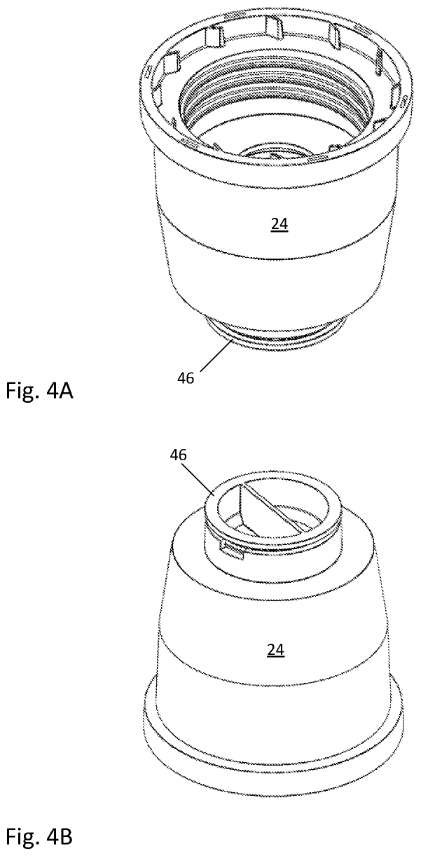

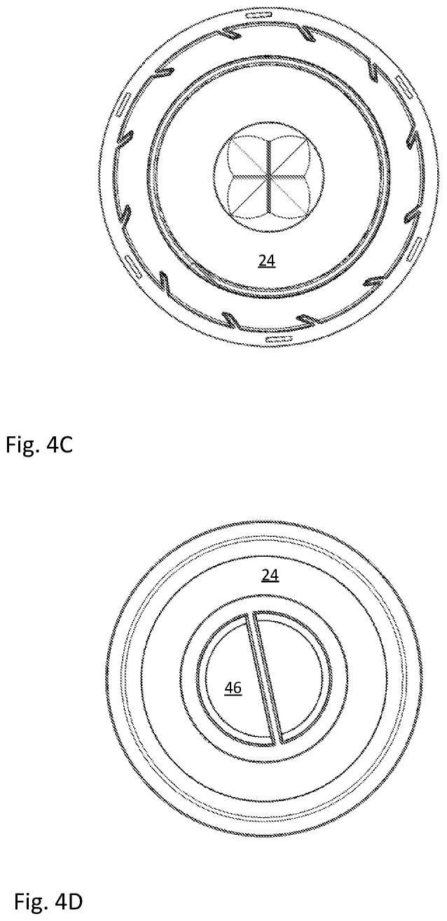

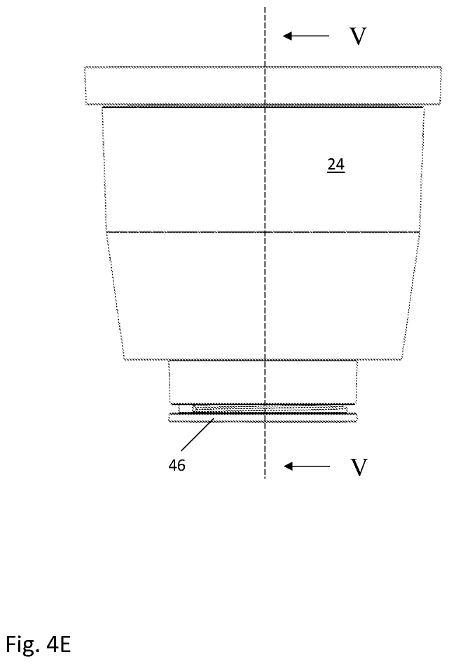

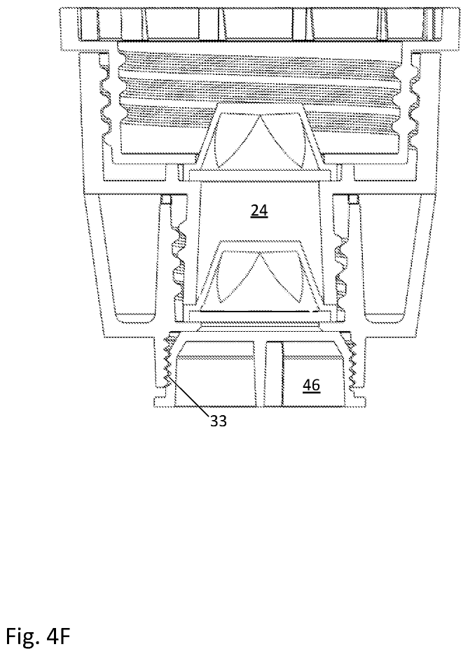

FIGS. 4A-4E depict similar views as FIGS. 3A-3E, except that the cap 24 is shown with a lid 46 for sealing the opening 37 of the fluid container 25. Such a lid 46 may be secured to the cap 24 when the fluid container 25 is not being used to dispensed fluid (e.g., is being transported from location to another). Bottom threads 32 of the cap 24 allow the lid 46 to be screwed onto the bottom end of the cap 24. Matching threads 33, as shown in FIG. 4F, may be present on the lid 46. While a screw-type securing mechanism has been described, it is understood that other securing mechanisms may be used to attach the lid 46 to the cap 24, including a bayonet mount, a tongue and groove mount, a friction fit mount, and ball-bearing lock type securing mechanism.

FIGS. 5A, 5B and 5C depict a top-side perspective, bottom-side perspective, and a side view of a cross-slit valve 38, respectively. The cross-slit valve 38 includes four petals 40a-40d that are each displaceable away from a central axis 52 of the cross-slit valve 38. While the cross-slit valve 38 as shown in FIGS. 5A-5C includes four petals, it is understood that other number of petals may be possible (with the exception that in configurations with more than four petals the valve may no longer be called a “cross-slit” valve). The cross-slit valve 38 is shown in FIGS. 5A-5C in a closed position, which blocks any fluid from passing through the valve. Each of the tips 54a-54d of the cross-slit valve 38 contains a slit which may open when force is applied along the axis 52 (i.e., in the upwards direction in the orientation of the cross-slit valve 38 shown in FIG. 5A). When all of the slits are opened at the same time, the slits may form a cross-shaped opening. Cross-slit valve 38 may be made from a pliable material such as silicone, rubber or a soft plastic. Cross-slit valves suitable for use in embodiments of the present invention are manufactured by miniValve International® with headquarters in Oldenzaal, The Netherlands.

Based on the above description, it should be apparent that the fluid dispensing system 100 may be operated as follows. First, the fluid container 25 may be oriented with respect to the container receptacle 15. More specifically, the opening 37 of the fluid container 25 may be oriented towards the rigid projecting member 18 of the container receptacle 15. Next, the rigid projecting member 18 that projects from the base portion 16 of the container receptacle 15 may be inserted through the opening 37 of the fluid container 25. Continued insertion of the rigid projecting member 18 into the fluid container 25 causes the rigid projecting member 18 to be inserted through the cross-slit valve 38b and subsequently through cross-slit valve 38a. Insertion of the rigid projecting member 18 through the cross-slit valve 38b may cause the respective tips of the petals of the cross-slit valve 38b to be displaced away from the central axis 48 of the fluid container 25. Similarly, insertion of the rigid projecting member 18 through the cross-slit valve 38a may cause the respective tips of the petals of the cross-slit valve 38a to be displaced away from the central axis 48 of the fluid container 25. The fluid container 25 is fully secured to the container receptacle 15 once the rim 28 of the neck body 36 rests on the base portion 16 of the container receptacle 15. When the rigid projecting member 18 penetrates through cross-slit valve 38a, fluid 19 from the fluid container 25 may start to flow into the tank 10 through the dispensing channel 20 of the rigid projecting member 18.

Thus, a system and method for dispensing fluid from a container with a stacked arrangement of cross-slit valves has been described. It is to be understood that the above-description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

### LIST OF REFERENCE NUMERALS

10 Tank (or vat)
12 Radiation-transparent flexible membrane
14 Tank sidewall
15 Container receptacle
16 Base portion
17 Collar
18 Rigid projecting member
19 Fluid
20 Fluid channel, dispensing channel
21 Fluid bottle
22 Opening (of bottle)
23 Bottle handle
24 Cap
25 Fluid container
26 Top rim
28 Bottom rim
30 Top threads (on cap)
32 Bottom threads (on cap)
33 Threads (on lid)
34 Cavity
35 Support member
36 Neck body
37 Opening (of fluid container)
38 Cross-slit valve
38a,b Cross-slit valves
40a-d Petals
42a Fill line
42b Fluid level
44 Groove
46 Lid
48 Central axis
50 Air
52 Central axis
54a-d Tips of petals
56 Outer surface of rigid projecting member
100 Fluid dispensing system

1. A fluid container, comprising:
a cavity for containing a fluid;
an opening for dispensing the fluid;
a neck body for regulating a flow of the fluid from the cavity, wherein a first end of the neck body is disposed adjacent to the cavity and a second end of the neck body forms the opening of the fluid container;
a first cross-slit valve secured to the first end of the neck body, wherein the first cross-slit valve comprises a first plurality of petals with respective tips that point away from the opening of the fluid container; and
a second cross-slit valve secured to the second end of the neck body, wherein the second cross-slit valve comprises a second plurality of petals with respective tips that point away from the opening of the fluid container,
wherein the neck body comprises a support member for securing the first cross-slit valve to the first end of the neck body and securing the second cross-slit valve to the second end of the neck body.

2. The fluid container of claim 1, wherein the neck body comprises a rim, and wherein the rim comprises a groove for ambient air to flow into the fluid container through the opening of the fluid container.

3. (canceled)

4. The fluid container of claim 1, wherein the first cross-slit valve is identical in shape to the second cross-slit valve.

5. The fluid container of claim 1, wherein the first plurality of petals comprises four petals.

6. The fluid container of claim 1, wherein the second plurality of petals comprises four petals.

7. The fluid container of claim 1, wherein the first cross-slit valve is configured to be penetrated by a rigid projecting member with a channel for dispensing the fluid.

8. The fluid container of claim 7, wherein the second cross-slit valve is configured to be penetrated by the rigid projecting member.

9. The fluid container of claim 1, wherein the fluid comprises photo-curable resin.

10. The fluid container of claim 1, wherein the cavity is formed by a bottle and a first portion of a cap, wherein the neck body is formed by a second portion of the cap, and wherein the cap is attached to an opening of the bottle.

11. A fluid dispensing system, comprising:
the fluid container of claim 1, and
a rigid projecting member with a channel, wherein the rigid projecting member is inserted through the opening of the fluid container, the second cross-slit valve, and the first cross-slit valve.

12. The fluid dispensing system of claim 11, further comprising:
a tank, wherein the channel of the rigid projecting member is fluidly connected with the tank, and wherein the tank is disposed below the fluid container so that the fluid from the fluid container flows into the tank.

13. The fluid dispensing system of claim 11, further comprising:
a container receptacle, wherein the a rim of the neck body rests on a base portion of the container receptacle, and wherein the rigid projecting member projects from the base portion towards the cavity of the fluid container.

14. A method comprising:
orienting the fluid container of claim 1 with respect to a container receptacle, wherein orienting the fluid container comprises orienting the opening of the fluid container towards the container receptacle;
inserting a rigid projecting member that projects from a base portion of the container receptacle through the opening of the fluid container;
inserting the rigid projecting member through the second cross-slit valve;
inserting the rigid projecting member through the first cross-slit valve; and
resting a rim of the neck body on the base portion of the container receptacle.

15. The method of claim 14, further comprising:
flowing the fluid from the fluid container into a tank through a channel of the rigid projecting member.

16. The method of claim 14, wherein inserting the rigid projecting member through the second cross-slit valve comprises displacing the respective tips of the second plurality of petals away from a central axis of the fluid container.

17. The method of claim 14, wherein inserting the rigid projecting member through the first cross-slit valve comprises displacing the respective tips of the first plurality of petals away from a central axis of the fluid container.
